(19) United States
(12) Patent Application Publication
(10) Pub. No.: US 2009/0326128 A1
(43) Pub. Date: Dec. 31, 2009

(54) FIBERS AND METHODS RELATING THERETO

(76) Inventor: Javier Macossay-Torres, Edinburg, TX (US)

Correspondence Address: FULBRIGHT & JAWORSKI L.L.P., 600 CONGRESS AVE., SUITE 2400, AUSTIN, TX, 78701, US

(21) Appl. No.: 12/117,567

(22) Filed: May 8, 2008

Related U.S. Application Data
(60) Provisional application No. 60/916,605, filed on May 8, 2007.

(51) Int. Cl. C08K 3/10; C08G 18/00; C08G 73/10; C08F 120/18; C08F 114/06; C08G 77/26; C08L 75/04; C08L 77/00; C08L 33/12; C08L 27/06; D01D 5/00

(52) U.S. Cl. 524/413; 528/44; 528/310; 526/329.7; 526/344.3; 528/25; 528/26; 524/589; 524/606; 524/560; 524/567; 524/435; 264/465; 977/773; 977/735; 977/742

(57) ABSTRACT

The present invention provides micro- and nanofibers made from polymers that comprise nanoparticles, such as carbon nanoparticles and inorganic nanoparticles, and methods of making such fibers.

### RELATED U.S. APPLICATION DATA

This application claims priority to U.S. Patent Application Ser. No. 60/916,605, filed on May 8, 2007, which is hereby incorporated by reference in its entirety.

### BACKGROUND OF THE INVENTION

I. Field of the Invention

The present invention relates generally to fiber technology, nanotechnology and, more particularly, to systems and methods for fabricating micro- and nanofibers and nanoparticle reinforced micro- and nanofibers.

II. Description of Related Art

Formhals described the process of electrospinning in several U.S. patents in the 1930's and 1940's to produce cellulose acetate, cellulose propionate and wool-cellulose acetate fibers. However, the process did not attract the attention of researchers until recently, as evidenced by the exponential increase in publications from less than 10 in 1994 to more than 250 in 2003. The driving force for the renewed interest in this technique is the possibility to produce inorganic and polymeric fibers with micrometer and nanometer size diameters. As compared to conventional polymer fibers with micrometer and larger scales, nanofibers have a high surface area-to-volume ratio. Hence, nanofibers may have better potential in several bioengineering applications, such as tissue regeneration, biosensors, recognition and filtration of viruses and drug molecules. The field of nanotechnology is still exploring methods and compositions to manipulate fiber properties in order to produce nanofiber materials having favorable properties for these and other applications.

### SUMMARY OF THE INVENTION

The proposed disclosure involves the production of polymer micro- and nanofibers optionally reinforced with nanoparticles. In one respect, fibers of the present invention incorporate carbon nanoparticles or inorganic nanoparticles into polymers that may render stronger and lighter fibers for various applications such as, but not limited to, tissue scaffolds, supports for enzymes and catalysts, filters, textiles, military or other clothing, electronic devices, optical devices, sensors, biosensors and reinforced composites. Micro- and nanofibers made of polymers without nanoparticles are also described herein.

Accordingly, the present invention generally contemplates a fiber comprising a polymer selected from the group consisting a polyurethane, a polyamide, poly(methyl methacrylate), poly(vinyl chloride) and blends thereof, wherein the diameter of the fiber ranges from about 1 nm to about 2 μm. In certain embodiments, the molecular weight of the polymer ranges between about 20,000-500,000 g/mol. In certain embodiments, the molecular weight of the polymer ranges between about 100,000-300,000 g/mol.

The fiber may comprise polyurethane, in certain embodiments, such as, for example, a poly(ester urethane), a poly(carbonate urethane), a silicone containing poly(ether urethane), a silicone containing poly(ester urethane), a silicone containing poly(carbonate urethane), or blends thereof. Ratios of the blends may range from 0% of polymer A/100% polymer B to 100% polymer A/0% polymer B. Similar ranges of proportions may be had for polymer blends of three polymers or more. The polyurethane may be further defined as Lycra®, Hydrothane™, Elasthane™, Biospan®, or blends thereof. Any polymer discussed herein may be blended with one or more polymers.

In certain embodiments, the fiber comprises a polyamide. Polyamides are well-known in the art, and polyamides of the present invention may be further defined as Nylon or Nylon 6,6, for example.

In certain embodiments, the fiber comprises poly(methyl methacrylate) or poly(vinyl chloride), or both.

Fibers of the present invention may comprise a nanoparticle. The nanoparticle may be a carbon nanoparticle or an inorganic nanoparticle, as those terms are defined here. In certain embodiments, the nanoparticle is a carbon nanoparticle. The carbon nanoparticle may be a diamond nanoparticle, graphite nanoparticle, buckyball nanoparticle, amorphous carbon nanoparticle, carbon onion nanoparticle, carbon nanotube, or carbon nanofiber. In particular embodiments, the carbon nanoparticle is a carbon nanotube or a carbon nanofiber. In particular embodiments, the carbon nanotube or carbon nanofiber is further defined as an oxidized carbon nanotube or an oxidized carbon nanofiber, respectively. The nanoparticle may be an inorganic nanoparticle, in certain embodiments. Inorganic nanoparticles may, for example, be selected from the group consisting of nanosilica, nanotitania, nanobarium titanate and nano(γ-Fe₂O₃). In certain embodiments, the fiber comprises a plurality of nanoparticles. The plurality of nanoparticles may comprise at least two types of nanoparticles (e.g., a carbon nanoparticle and an inorganic nanoparticle, or two types of carbon nanoparticles, or two types of inorganic nanoparticles). In certain embodiments, the total weight percentage of nanoparticles in the fiber ranges from about 0.001-10%. (e.g., about 0.001%, 0.010%, 0.050%, 0.075%, 0.10%, 0.50%, 1.0%, 2.0%, 3.0%, 4.0%, 5.0%, 6.0%, 7.0%, 8.0%, 9.0%, 10%, or any range derivable therein).

The fiber may have any diameter found between about 1 nm to about 2 μm. For example, in certain embodiments, the fiber may have a diameter of about 1-1000 nm (e.g., 1-100 nm, 1-500 nm, 100-900 nm, 400-600 nm, etc.). In certain embodiments, the fiber has a diameter of about 1-2 μm. In certain embodiments, the diameter ranges from about 800 nm to about 2 μm. In certain embodiments, the diameter ranges from about 500 nm to about 2 μm. In certain embodiments, the fiber is further defined as a nanofiber, as that term is defined herein.

Other general aspects of the present invention contemplate a nanofiber comprising: (a) a polymer selected from the group consisting a polyurethane, a polyamide, poly(methyl methacrylate), poly(vinyl chloride) and blends thereof, and (b) a nanoparticle. Any polymer discussed above and herein may be comprised in such a nanofiber. In certain embodiments, the nanoparticle may be further defined as a carbon nanoparticle or an inorganic nanoparticle. Any such carbon nanoparticle or inorganic nanoparticle as described above and herein may be comprised in such a nanofiber. The diameter of the nanofiber may be further defined as a any range of nanofibers contemplated herein (e.g., 1-100 nm, 1-500 nm, 100-900 nm, 400-600 nm, etc.).

Another aspects of the present invention contemplate a fiber comprising: (a) a polymer selected from the group consisting a polyurethane, a polyamide, poly(methyl methacrylate), poly(vinyl chloride) and blends thereof, and (b) a nanoparticle, wherein the fiber has a diameter of 1-2 μm.

Methods of making fibers of the present invention are also contemplated. For example, the present invention contemplates a method of making a fiber comprising: (a) dispersing a plurality of nanoparticles into a polymer to form a nanoparticle-dispersed polymer; and (b) creating a fiber from the nanoparticle-dispersed polymer, wherein the diameter of the fiber ranges from about 1 nm to about 2 μm, and wherein the polymer is selected from the group consisting of a polyurethane, a polyamide, poly(methyl methacrylate), poly(vinyl chloride) and blends thereof. The nanoparticles may be of any type described herein, such as carbon nanoparticles or inorganic nanoparticles. The nanoparticles may be further defined as a carbon nanofibers, oxidized carbon nanofibers, carbon nanotubes, oxidized carbon nanotubes, nano-silica nanoparticles, nano-titania nanoparticles, nano-barium titanate nanoparticles, or nano(γ-Fe₂O₃) nanoparticles. The total weight percentage of nanoparticles added to the polymer may range from about 0.001-10% wt/wt (e.g., about 0.001%, 0.010%, 0.050%, 0.075%, 0.10%, 0.50%, 1.0%, 2.0%, 3.0%, 4.0%, 5.0%, 6.0%, 7.0%, 8.0%, 9.0%, 10%, or any range derivable therein). The polymer may be any polymer described herein, such as a polymer selected from the group consisting of Lycra®, Hydrothane™, Elasthane™, Biospan®, Nylon 6, Nylon 6,6, poly(methyl methacrylate) and poly(vinyl chloride). In certain methods, the polymer is dissolved in at least one solvent prior to dispersion of the nanoparticles. The solvent may be any solvent discussed herein, such as DMF, DMAC, THF, HFIP, N-cyclohexyl-2-pyrrolidone, formic acid, and mixtures thereof. The weight percentage of the polymer in the solvent may range from about 1-25% wt/wt (e.g., 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24% or 25%, or any range derivable therein). The fiber may be generated using any method known in the art, such as electrospinning.

In certain embodiments, methods of making nanofibers are contemplated. For example, the present invention may comprise a method of making a nanofiber comprising: (a) dispersing a plurality of nanoparticles into a polymer to form a nanoparticle-dispersed polymer; and (b) electrospinning the nanoparticle-dispersed polymer to form the nanofiber, wherein the polymer is selected from the group consisting of a polyurethane, a polyamide, poly(methyl methacrylate), poly(vinyl chloride) and blends thereof. Any polymer and any nanoparticle discussed herein may be employed in such methods.

As used herein, “nano” refers to sizes of about 1-1000 nanometers (nm) (e.g., 0.5-100 μm).

As used herein, “micro” refers to sizes of about 1001 nm to about 1000 micrometers (μm) (e.g., 1-100 μm, 1-10 μm, 1-2 μm, etc.).

The terms “a” and “an” are defined as one or more unless this disclosure explicitly requires otherwise.

The use of the term “or” in the claims is used to mean “and/or” unless explicitly indicated to refer to alternatives only or the alternatives are mutually exclusive, although the disclosure supports a definition that refers to only alternatives and “and/or.”

The term “about” refers to ranges within 10% of what is specified, such as within 7.5%, within 5%, within 2%, within 1%, within 0.5%, etc.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has,” or “includes” one or more steps is not limited to possessing only those one or more steps and also covers other unlisted steps. Furthermore, a device or structure that is configured in a certain way is configured in at least that way, but may also be configured in ways that are not listed.

It is specifically contemplated that any limitation discussed with respect to one embodiment of the invention may apply to any other embodiment of the invention. Furthermore, any composition of the invention may be used in any method of the invention, and any method of the invention may be used to produce or to utilize any composition of the invention.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one of these drawings in combination with the detailed description of specific embodiments presented herein.

FIGS. 1A-C show scanning electron micrographs (SEMs) of PMMA nanofibers, in accordance with embodiments of the present disclosure.

FIG. 2 shows a thermogravimetric analysis (TGA) of powder PMMA and PMMA nanofibers obtained with a plurality of different needle diameters, in accordance with embodiments of the present disclosure.

FIGS. 3A-G show a differential scanning calorimetry (DSC) of various of nanofibers subjected to different temperatures, in accordance with embodiments of the present disclosure. a) powder PMMA, PMMA nanofibers: b) 1^{st} heating cycle, nanofiber obtained with 0.83 mm ID, c) 2^{nd} heating cycle, nanofiber obtained with 0.83 mm ID, d) 1^{st} heating cycle, nanofiber obtained with 0.4 mm ID, e) 2^{nd} heating cycle, nanofiber obtained with 0.4 mm ID, f) 1^{st} heating cycle, nanofiber obtained with 0.1 mm ID, g) 2^{nd} heating cycle, nanofiber obtained with 0.1 mm ID.

FIGS. 4A-B show scanning electron micrographs of electrospun microfibers of (a) PMMA (7.5 wt. %) in 1:1 THF/DMF and (b) PMMA (7.5 wt. %)/CHP (0.6 wt. %)/CNFs (0.002 wt. %) in 1:1 THF/DMF, respectively, in accordance with embodiments of the present disclosure.

FIGS. 5A-B show transmission electron micrographs of an electrospun microfiber of PMMA (7.5 wt. %)/CHP (0.6 wt. %)/CNFs (0.002 wt. %) in 1:1 THF/DMF, in accordance with embodiments of the present disclosure. The arrows indicate the presence of CNFs within the PMMA.

### DETAILED DESCRIPTION OF THE INVENTION

The present invention is based on the discovery that various polymers may be combined with nanoparticles to produce micro- and nanofibers having favorable properties, such as fibers having improved strength, improved heat resistance, and/or lighter weights when compared to fibers that do not possess such nanoparticles. Accordingly, the present invention contemplates nanoparticle reinforced micro- and nanofibers and methods of making and using these fibers. Micro- and nanofibers without nanoparticles are also described herein. In certain embodiments, polymers without nanoparticles formed into micro- and nanofibers exhibit different properties than polymers found in other configurations.

### I. POLYMERS OF THE PRESENT INVENTION

Various polymers and polymer blends may be employed in methods of the present invention to produce micro- and nanofibers and nanoparticle reinforced micro- and nanofibers. Ranges of molecular weights for polymers that may be employed in the present invention include about 20,000-500,000 g/mol, such as about 100,000-300,000 g/mol. Non-limiting examples of polymers are described below. Combinations of these polymers are also contemplated by the present invention.

A. Polyurethanes

Polyurethanes may be used to create nanoparticle reinforced micro- and nanofibers of the present invention. Non-limiting examples of classes of polyurethanes include poly(ester urethanes), poly(carbonate urethanes), silicone containing poly(ether urethanes), silicone containing poly(ester urethanes), silicone containing poly(carbonate urethanes), and blends thereof. Non-limiting examples of members of these classes of polyurethanes include PurSil®, Bionate® and Carbosil®, and many others are known to those of ordinary skill in the art. Other non-limiting specific examples of polyurethanes include Lycra®, Hydrothane™, Elasthane™ and Biospan®, and blends thereof. Other names associated with Lycra® include poly(ether urethane) urea, segmented polyurethane, elastane and spandex. Chemically modified derivatives of members of the classes discussed herein are also contemplated, such as co-polymers made from members of these classes. In certain embodiments, polyurethanes such as Lycra® may be used in nanoparticle reinforced micro- and nanofibers of the present invention for textile and apparel purposes.

Polyurethanes may be acquired from various commercial suppliers. For example, Elasthane™ and Biospan® may be obtained from The Polymer Technology Group (Berkeley, Calif.); Hydrothane™ (hydrophilic and elastic) may be obtained from Cardiotech International (Wilmington, Mass.); and Lycra® may be obtained from Invista (formerly DuPont) (Wichita, Kans.).

B. Polyamides

Another example of a class of polymer that may be used in methods and compositions of the present invention is polyamides, such as nylon. Non-limiting examples of nylon include Nylon 6 (also known as poly-ε-caprolactam, polycaprolactam and polyamide 6) and Nylon 6,6 (also known as polyhexamethylene adipamide). Nanoparticle reinforced polyamide micro- and nanofibers of the present invention may be used in textiles and other performance materials, for example.

Polyamides may be acquired from various commercial suppliers. For example, Nylon 6 and Nylon 6,6 may each be obtained from Dupont (e.g., Nylon 6: Zytel® 7301 NC010; Nylon 6,6: Zytel® 101L NC010).

C. Other Polymers

(1) Poly(Methyl Methacrylate)

Poly(methyl methacrylate) (PMMA) or poly(methyl 2-methylpropenoate) is a synthetic polymer of methyl methacrylate. This thermoplastic and transparent plastic is sold under a variety of tradenames (e.g., Plexiglas®, Perspex® and Lucite®) and is commonly called acrylic glass or acrylic. PMMA is widely commercially available, such as from Alfa Aesar.

(2) Poly(Vinyl Chloride)

Polyvinyl chloride (polychloroethene), commonly abbreviated PVC, is a widely used thermoplastic polymer. In terms of revenue generated, it is one of the most valuable products of the chemical industry. PVC is available from a variety of commercial sources, such as from Sigma.

### II. NANOPARTICLES OF THE PRESENT INVENTION

Reinforcement of polymeric materials with different inorganic and organic materials may afford properties not usually obtained by the polymer itself (Schlumpf, 1996; Lyon et al., 1990; Stoy and Washabaugh, 1990). Nanoparticles that may be mixed with polymers of the present invention include carbon nanoparticles and inorganic nanoparticles, as described herein. Certain embodiments of the present invention contemplate combinations of these nanoparticles. Typically, the total amount of nanoparticles that may be included in methods of the present invention ranges from about 0.001-10 wt. % of a polymer or polymer solution, such as about 0.001-0.01%, about 0.1-1%, about 1-5%, etc.

A. Carbon Nanoparticles

Fibers of the present invention may comprise carbon nanoparticles. Carbon nanoparticles, as used herein, are carbon allotrope nanoparticles such as diamond nanoparticles, graphite nanoparticles, buckyball nanoparticles, amorphous carbon nanoparticles, carbon onion nanoparticles, carbon nanotubes (CNTs) and carbon nanofibers (CNFs). Some of these carbon allotrope nanoparticles are described in further detail below.

Carbon onions are concentric graphene spherical shells. Syntheses and various properties of carbon onions are described in, e.g., U.S. Pat. No. 6,599,492, incorporated herein by reference. In certain embodiments of the present invention, the addition of carbon onion nanoparticles to polymers of the present invention to produce reinforced micro- and nanofibers results in fibers that may act as better lubricating agents than the micro- and nanofibers without the addition of such nanoparticles.

CNTs include single walled carbon nanotubes (SWNTs) and multiwalled carbon nanotubes (MWNTs). These compounds and CNFs have different structures and morphologies: while SWNTs are materials made of hollow single rolled up graphene sheets, MWNTs consist of multiple concentric sheets with a hollow core. CNFs, however, include hollow or solid graphene sheets with stacked cones, stacked cups or plates morphologies (Salvetat et al., 1999).

CNTs and CNFs are materials with conjugated C—C sp² bonds, which results in strong covalent bonds and a remarkable hexagonal network that is capable of distortions for relaxing stress (Salvetat et al., 1999; Salvetat-Delmotte and Rubio, 2002). As a consequence, these carbon allotropes have a unique combination of high strength, flexibility and stiffness, which makes them quite attractive for reinforcing polymer matrices (Qian et al., 2000). Carbon nanotubes (CNTs), which are the toughest materials known to date, possess a theoretical Young modulus of 1 TPa and are being studied intensively as polymer reinforcement agents (Calvert, 1999; Ajayan et al., 1994; Xie et al., 2005; Jin et al., 1998; Lozano and Barrera, 2001; Robertson, 2004; Qian et al., 2000).

Theoretical and experimental studies have indicated that SWNTs have a Young modulus of approximately 1 TPa and tensile strength from 13-53 GPa, while MWNTs possess a Young modulus at 0.9 TPa and tensile strength up to 150 GPa. In contrast, CNFs present more modest mechanical properties with Young modulus varying from 4-6 GPa and tensile strength around 0.2-0.3 GPa (Salvetat et al., 1999; Salvetat-Delmotte and Rubio, 2002; Demczyk et al., 2002; Meo and Rossi, 2006).

However, the same chemical nature (sp² hexagonal networks) that provides high strength, flexibility and stiffness to CNTs and CNFs is responsible for strong π-π interactions between adjacent graphene sheets: as a consequence, these interactions promote Van der Waals forces that result in CNTs and CNFs aggregating in bundles. As a result, disentanglement and dispersion of CNTs and CNFs has become one of the most challenging issues to overcome when using these nanomaterials as reinforcing fillers in polymer matrices (Qian et al., 2000).

Presently, CNTs may be obtained in small amounts at very high prices, while CNFs present modest properties but are produced in bulk quantities at lower prices. CNFs and CNTs may be obtained from various commercial sources, such as Applied Sciences, Inc. (Cedarville, Ohio) and Nanointegris, Nano-C, mknano, and Cheap Tubes, Inc.

Oxidized carbon nanofibers and oxidized carbon nanotubes may also be employed in methods of the present invention. One non-limiting oxidation method is based on the work of Dadmun (Rasheed et al., 2007), where CNFs were oxidized with 6M HNO₃, KMnO₄, RuO₄ and HNO₃/H₂SO₄. CNTs may be oxidized using similar methodology. The product of this reaction, or any other reaction involving oxidation of a CNF or CNT, is an “oxidized CNF” or “oxidized CNT,” as used herein. The ratio of ordered graphitic bands to disordered graphitic sites was determined using Raman spectroscopy and allowed the authors to correlate the reaction conditions to chemical modification. Therefore, one can select different conditions to produce various oxidized CNT and CNF products.

In certain embodiments of the present invention, CNF and/or CNT reinforced micro- or nanofibers may improve the strength of the micro- or nanofiber over its strength without the addition of the nanoparticles. In certain embodiments, CNF and/or CNT reinforced micro- or nanofibers may improve heat resistance of the micro- or nanofiber over its heat resistance without the addition of the nanoparticles.

B. Other Nanoparticles

Besides carbon nanoparticles, other nanoparticles may be combined with polymers of the present invention to produce nanoparticle reinforced nanofibers, such as inorganic nanoparticles—that is, nanoparticles wherein the majority of atoms are any other atoms different than carbon. Non-limiting examples of inorganic nanoparticles include nanosilica (nano-SiO₂), nanotitania (nano-TiO₂), nanobarium titanate (nano-BaTiO₃) and nano(γ-Fe₂O₃). These nanoparticles may be obtained from Aldrich, for example.

In certain embodiments of the present invention, nanosilica reinforced micro- or nanofibers may improve the strength of the micro- or nanofiber over its strength without the addition of the nanoparticles. In certain embodiments, nanosilica-reinforced micro- or nanofibers may improve heat resistance of the micro- or nanofiber over its heat resistance without the addition of the nanoparticles.

In certain embodiments of the present invention, nanotitania, nanobarium, and/or nano(γ-Fe₂O₃) reinforced micro- or nanofibers may impart the ability of that micro- or nanofiber to respond to an external electric field. For example, dielectric electrospun micro- and nanofibers may be used in artificial muscles.

### III. METHODS OF MAKING NANOPARTICLE REINFORCED MICRO- AND NANOFIBERS

### A. Methods of Making Micro- and Nanofibers

Methods of making microfibers are well-known in the art, such as wet spinning, dry spinning, melt spinning and gel spinning processes. See, e.g., U.S. Pat. No. 6,432,532, incorporated herein by reference in its entirety. Presently, the most common method used to make nanofibers is through the use of electrospinning. Microfibers with and without nanoparticles may also be produced using electrospinning. Electrospinning may be employed to create nanoparticle reinforced micro- and nanofibers of the present invention as well as micro- and nanofibers having no nanoparticles.

The electrospinning process includes placing a polymer or polymer solution in a syringe equipped with a needle or capillary tube attached to a high power source, which may generate a high voltage difference between the needle and a grounded target, usually ranging from about 2-50 kV. As the polymer solution is ejected from the syringe, the electrical charges in the polymer and the solvent may induce evaporation of the latter, leaving a dry polymer fiber to deposit on a grounded target. Fiber diameter may be increased with, e.g., higher polymer concentration and decreased by, for example, increasing voltage.

As one example, the present invention contemplates an electrospinning method comprising mixing PMMA with dimethylformamide (DMF) and N-cyclohexyl-2-pyrrolidone (CHP) and to form a solvent mixture, mixing CNFs with the solvent mixture, and creating nanofibers from that product. Proportions of polymer and nanoparticles are discussed herein.

Other methods of making micro- and nanofibers are also possible, such as through melt spinning as described in U.S. Pat. No. 6,382,526; methods described by Quintero et al. (2007) and centrifuge spinning as described in Dauner (2006). Each of these references are incorporated herein by reference, and each may be employed to produce nanoparticle reinforced micro- nanofibers of the present invention.

### B. Incorporation of Nanoparticles Into Polymers of the Present Invention

A variety of methods may be employed to incorporate nanoparticles into polymers to produce nanoparticle reinforced micro- and nanofibers. Non-limiting examples of polymers, polymer solutions, and dispersion methods are provided below.

Polymers of the present invention may be dissolved into a solvent prior to the addition of nanoparticles. Polymer concentrations that may be employed in methods of the present invention wherein a polymer is dissolved in a solvent may range between, for example, about 1-25% wt/wt. For example, a polymer concentration may be about 2.5%, 5%, 7.5%. 10%, 15%, 20% or 25%.

Non-limiting examples of such solvents include DMF, dimethylacetamide (DMAC), tetrahydrofuran (THF), 1,1,1,3,3,3-hexafluoro-2-propanol (HFIP) and N-cyclohexyl-2-pyrrolidone. Formic acid may also be used. In certain embodiments, HFIP may be used alone or may be combined with formic acid. Proportions of HFIP and formic acid may range from 0% formic acid/100% HFIP to 100% formic acid/0% HFIP. Indeed, when combining solvents, similar ratios may also be employed (that is from 0% solvent A/100% solvent B and from 100% solvent A/0% solvent B). Proportions of solvent mixtures having three or more solvents may be used as well, and may span similar ranges.

In a non-limiting example, Nylon 6 and Nylon 6,6 may be dissolved in HFIP or formic acid, or a combination thereof. In another non-limiting example, Lycra® (e.g., 2.5-7.5%, such as 5%) may be dissolved in DMAC or mixtures of DMAC and THF (e.g., 0% DMAC/100% THF up to but not including 100% DMAC/0% THF). Other examples include: 7.5 wt. % PMMA mixed with 1:1 THF:DMF; PVC (11 wt. %) mixed with 1:1 THF:DMF; 7.5 wt. % Nylon 6 mixed with HFIP; and 7.5 wt. % Nylon 6,6 mixed with HFIP.

Polymers need not be dissolved prior to incorporation by nanoparticles: that is, “neat” polymers may be combined with nanoparticles produce nanoparticle reinforced micro- and nanofibers of the present invention.

A variety of dispersion methods are known for incorporating nanoparticles into polymers of the present invention. For example, melt spinning may be employed. Alternatively, extrusion may be employed wherein pellets are obtained that may be further processed into micro- and/or nanofibers (Yang et al., 2004; Benitz et al., 2007). Nanoparticles may be dispersed directly, or may be manipulated prior to addition to a polymer, such as described below.

Regarding CNTs and CNFs in particular, certain methods of the present invention contemplate dispersing these nanoparticles directly or by using solvents: for example, CNTs and CNFs may be dispersed in a solvent, and then added into a polymer of the present invention. Solvents for this purpose include, but are not limited to, N-cyclohexyl-2-pyrrolidone, DMF and DMAC. Surfactants and various polymers may also be used to disperse CNTs in polymers. For example, CNTs may be dispersed into polyaniline, poly(vinyl) alcohol, or sodium dodecyl sulfate and then added into a polymer of the present invention.

Turning to inorganic nanoparticles of the present invention, organic compounds such as organic phosphonic acids may be used to disperse inorganic nanoparticles in polymers of the present invention. Such organic phosphonic acids may encapsulate a nanoparticle, and that encapsulated material may then be dispersed into a polymer of the present invention. See, e.g., world wide web at gtresearchnews.gatech.edu/newsrelease/barium-titanate.htm.

In certain embodiments of the present invention, nanoparticles are incorporated into a polymer as follows: a polymer (described above) is dissolved in a solvent or combination of solvents in a concentration ranging from, e.g., about 1-25% wt/wt, and the solution is stirred anywhere from about 1 to about 24 hours (e.g., overnight), depending on the speed of the stirring (that is, the higher the speed of stirring, the less time is needed to mix the solution). Next, nanoparticles are added in amounts ranging from about 0.01-10 wt. % of the polymer solution, and the solution is exposed to high frequency ultrasound (e.g., sonication) for a period of time ranging from about 10 minutes to about 3 hours, such as about 30-40 minutes. The sample is then formed into micro- or nanofibers, such as through the use of electrospinning. In certain embodiments, formation of the fiber following dispersion of the nanoparticles takes place without delay in order to avoid nanoparticle sedimentation.

### IV. CHARACTERIZATION OF NANOPARTICLE REINFORCED MICRO- AND NANOFIBERS

Micro- and nanofibers of the present invention as well as nanoparticle reinforced micro- and nanofibers may be characterized using methods known in the art. For example, SEM may provide evidence of the fiber surface morphology and diameter. Such evidence may be correlated with the method in which the fiber was made. Regarding electrospinning methods, for example, studies have demonstrated that low polymer concentrations during electrospinning afford beads or bead-strings (pearl necklace) structures as shown by SEM, while high concentrations are known to increase fiber diameters (Megelski et al., 2002; Lee et al., 2003).

Other characterization methods are available. For example, thermal properties may be investigated using Thermogravimetric Analysis (TGA) or Differential Scanning Calorimetry (DSC). TGA may provide information on the decomposition steps and decomposition temperatures of the materials. To complement this information, DSC may provide information on phase transitions, such as glass transition temperatures (T_{g}), crystallization and melting temperatures.

Mechanical characterization of the fibers may be performed using a microtensile tester. This technique provides information such as Young modulus, stiffness, tensile strength and ultimate tensile load.

Regarding the distribution of nanoparticles within the nanoparticle reinforced fibers, characterization by SEM, TGA, or DSC may be performed. Additional techniques that may be used to determine properties of nanoparticle reinforced micro- and nanofibers include Transmission Electron Microscopy (TEM) and Raman spectroscopy. TEM may be used to investigate nanoparticle dispersion and alignment within the fibers (Macossay et al., 2006; Li and Xia, 2004; Dror et al., 2003). Raman spectroscopy may provide information on the intermolecular interactions between nanoparticles and the fibers. Other methods include atomic force microscopy (AFM), Fourier transform infrared spectroscopy (FTIR), tensile testing and x-ray diffraction.

### V. Examples

The following examples are included to demonstrate certain preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

### Materials and Methods

### Electrospinning

Polymer fibers were injected using a 10 mL glass syringe with an 18 needle gauge (1.23 mm OD×0.83 mm ID (internal diameter)), a 22 needle gauge (0.7 mm OD×0.4 mm ID), or a 26 needle gauge (0.45 mm OD×0.1 mm ID) at a flow rate of about 0.05 mL/min as controlled using a KDS 210 pump (KD Scientific Holliston Inc., MA). One of ordinary skill in the art can recognize that the needle gauge may vary depending on the desired diameter and may range from 8-34 gauge. A high power supply, ES30P-5W (Gamma High Voltage Research, Ormond Beach, Fla.) was also used. The equipment was coupled to the needle tip through an alligator clip and a voltage difference of between 5-50 kV, and in particular, 15 kV was used, and the grounded target was placed at 24.5 cm from the needle tip, although distances from between 5 to 50 centimeters may also be used.

### Scanning Electron Microscopy (SEM)

For SEM analyses, a Leo 435 VP (Leo Electron Microscopy Ltd) was used to determine the diameters of the produced fibers. The samples were coated with a thin layer of palladium in two 30 second consecutive cycles at 45 milliamps with, for example, a Desk II Denton Vacuum Cold Sputter.

### Thermogravimetric Analysis (TGA)

Thermogravimetric analysis was performed using a Perkin Elmer TGA 7 under nitrogen with a flow rate of 20 mL/min. The samples were ramped from room temperature to 800° C. at a scanning rate of 10° C./min using platinum pans.

### Differential Scanning Calorimetry (DSC)

DSC studies were performed using a Perkin-Elmer DSC 7 under nitrogen with a flow rate of 20 mL/min. The samples were ramped from room temperature to 250° C. at a scanning rate of 10° C./min using alumina pans.

### Example 2

### Electrospun PMMA Nanofibers

Polymer samples were prepared by dissolving 7.5 wt. % PMMA in a 1:1 THF:DMF solvent mixture. PMMA (350,000 g/mol; Alfa Aesar); THF and DMF (Sigma-Aldrich), used without further purification.

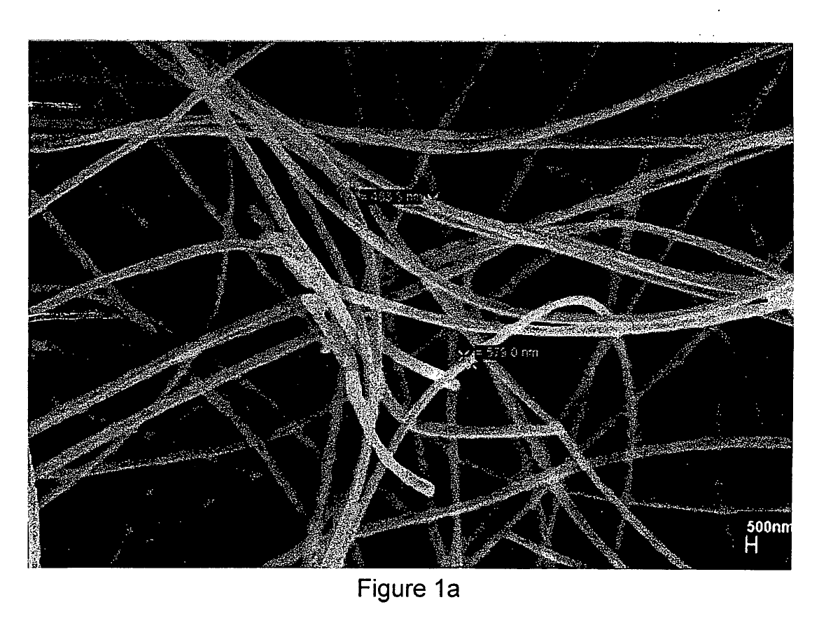

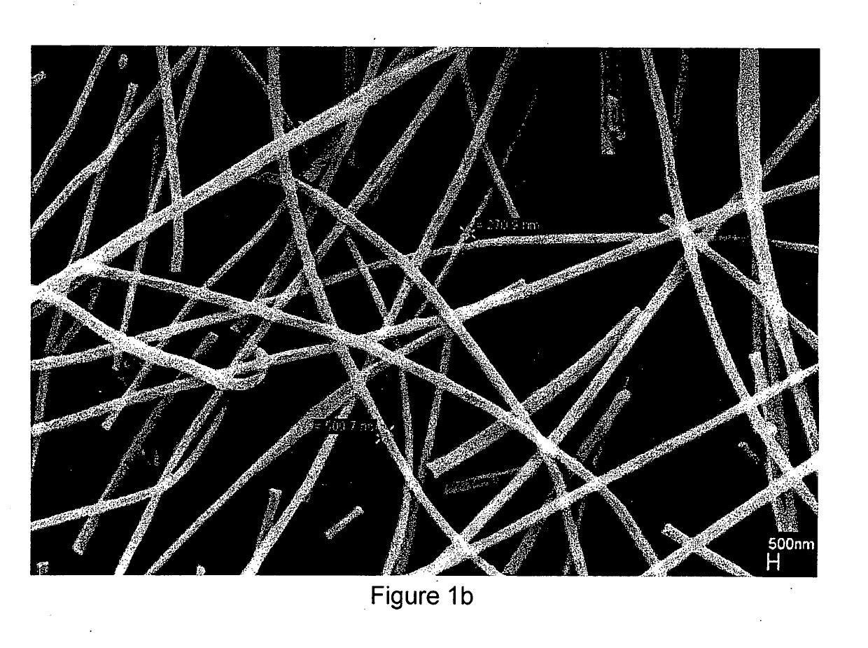

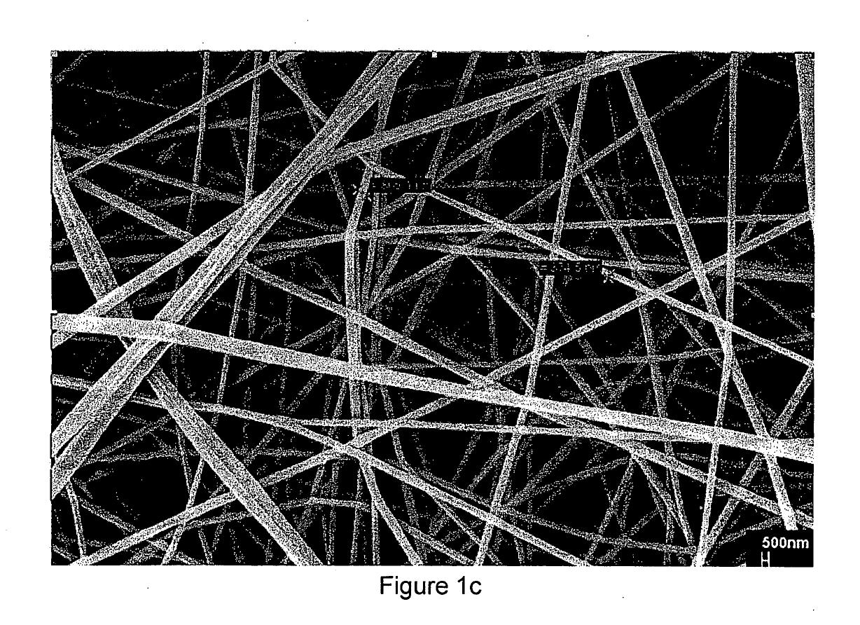

SEM micrographs of PMMA nanofibers obtained with needles with different internal diameters are presented in FIG. 1A-C. These fibers presented regular surface morphologies with a few nanofiber bundles being evident in FIGS. 1A-C. The resulting PMMA non-woven mats were analyzed (10-12 individual nanofiber diameters were measured) to calculate the average nanofiber diameter and standard deviation.

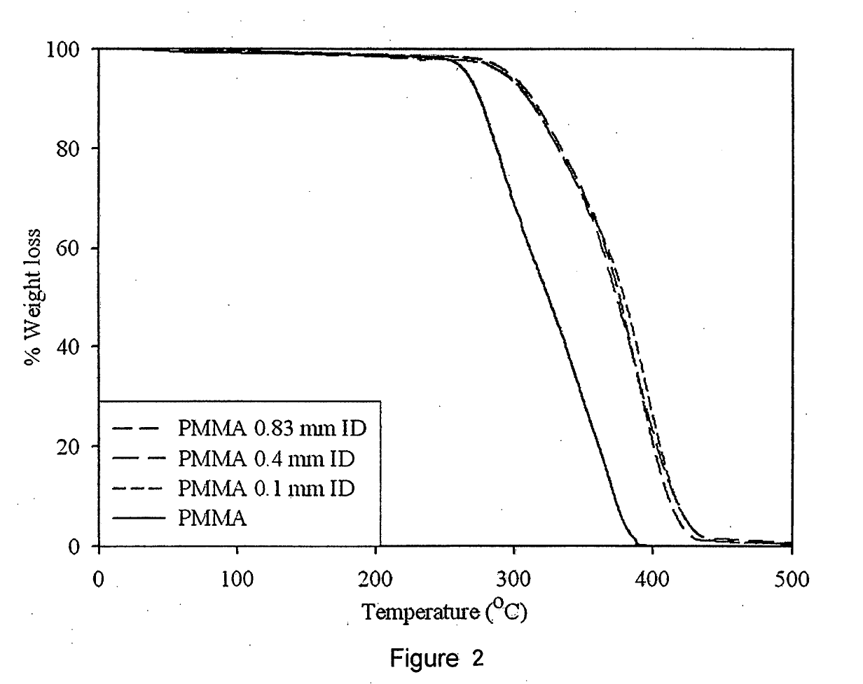

The thermogravimetric analysis (TGA) of PMMA samples in powder form and nanofibers are shown in FIG. 2, presenting all the samples a one step decomposition process. The TGA indicated an unexpected increase of about 40° C. in the onset decomposition temperature of PMMA from the powder form (about 266° C.) to the nanofiber (about 306° C.). Reports on TGA for polymer samples before and after electrospinning are scarce and a study of commercial poly(ethylene terephthalate) (PET) and subsequent electrospun PET nanofibers presented one decomposition step at the same temperature for both samples. Kim and Lee, 2000. Nevertheless, it has been demonstrated that solution electrospinning of poly(L-lactic acid) (PLA) resulted in non-crystalline samples with a high degree of chain orientation, while electrospun nanocomposites of PLA/clays, nylon 6/montmorillonite, and PMMA/carbon nanofibers have resulted in aligned nanoparticles and/or aligned polymer chains (Zong et al., 2002). Therefore, the PMMA chains may be aligning during the stretching and whipping that occurs in the electrospinning process, resulting in nanofibers with ordered structures and therefore the higher thermal stabilities observed. Furthermore, TGA indicated that all nanofibers obtained with the different needle diameters presented the same decomposition temperature, indicating that the thermal stability may be independent of the needle diameter.

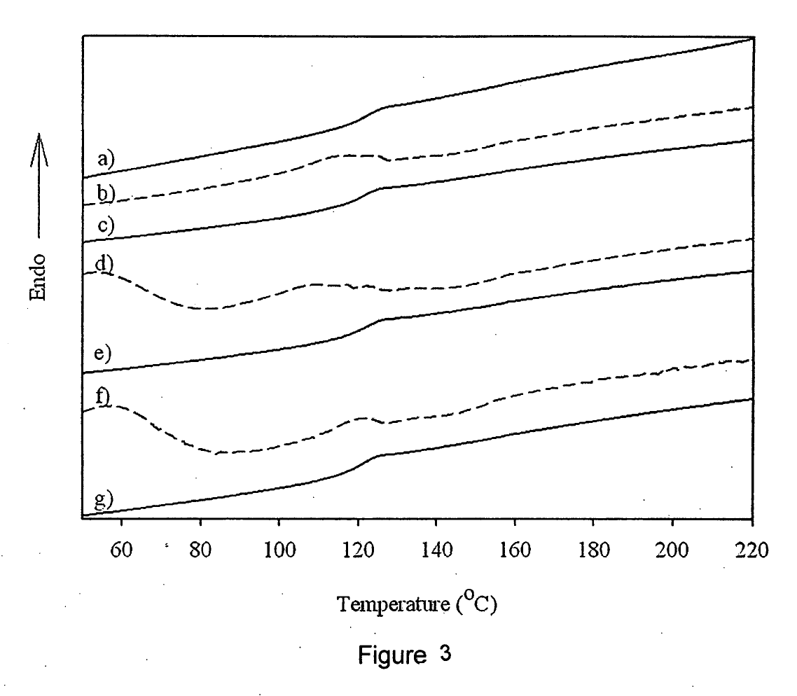

PMMA in powder form presented a glass transition temperature (T_{g}) of about 122° C. (FIG. 3A), whereas the T_{g} of electrospun PMMA nanofibers were determined at about 109° C. for 0.83 mm ID (FIG. 3B), about 102° C. for 0.4 mm ID (FIG. 3D), and about 116° C. for 0.1 mm ID (FIG. 3F) in the first heating cycle. When the samples were subjected to a second heating cycle, the T_{g} values were about 120° C. (FIG. 3C), about 122° C. (FIG. 3E) and about 122° C. (FIG. 3G) respectively, corresponding to the T_{g} of powder PMMA. The lower T_{g} suggests that there may be an increase in the segmental mobility of the polymer chains within the nanofibers, but this enhanced mobility may be decreased after the first heating cycle. Lower T_{g} values and degrees of crystallization are known for electrospun fibers (Kim and Lee, 2000; Macossay et al., 2007; Zong et al., 4403; Shao et al., 2003), and although the nature of the former effect has not been thoroughly studied, it may be attributed to air acting as a plasticizer for polylactic acid (PLLA) nanofibers. FIGS. 3D and 3F revealed endotherms for the PMMA nanofibers in the first heating cycle, which were not found in the second heating cycle, where the nanofibers presented the same T_{g} as the powder PMMA. These results suggest the possibility of water absorption from the surroundings as the nanofiber travels from the needle to the target. The water absorbed may plasticize the nanofibers and decrease the T_{g} in the first heating cycle, but once water was removed from the nanofibers, the T_{g} values coincided with powder PMMA. Finally, in accordance with the SEM and TGA results, there was no evidence found in the DSC thermograms that the needle diameter affects the T_{g} of the nanofibers.

In one respect, PMMA nanofibers were obtained utilizing needles with different internal diameters. The results obtained from SEM analysis clearly indicated that there was no correlation between the needle diameter used and the average nanofiber diameter obtained in the solution electrospinning process, but a broader range of nanofibers diameters was obtained with smaller needle diameter. In addition, PMMA nanofibers presented an unexpected enhanced thermal stability compared to the starting PMMA, which was in powder form. Furthermore, DSC analysis demonstrated the presence of an endotherm in the electrospun PMMA nanofibers, which could be attributed to water absorbed during the electrospinning process, lowering the glass transition temperatures encountered in the nanofibers during the first heating cycle. Finally, the thermal stability and glass transition temperature were also independent of the needle diameter utilized to obtain the nanofibers.

### Example 3

### CNF-Reinforced Micro- and Nanofibers

PMMA (7.5%, 350,000 g/mol; Alfa Aesar) was dissolved in 1:1 THF/DMF. Next, 0.02 wt. % CNFs (vapor grown carbon nanofibers (Pyrograph III™) PR-24-RAW with diameters of 50-200 nm supplied by Applied Sciences, Inc. and purified according to the procedure reported by Lozano and collaborators (Lozano et al., 1999) were added and the solution was stirred vigorously for 20 hours.

In a separate experiment, 1.0 wt. % CHP was added to 7.5% PMMA in 1:1 THF/DMF, followed by addition of 0.002 wt. % CNFs. Vigorous stirring took place for 20 hours.

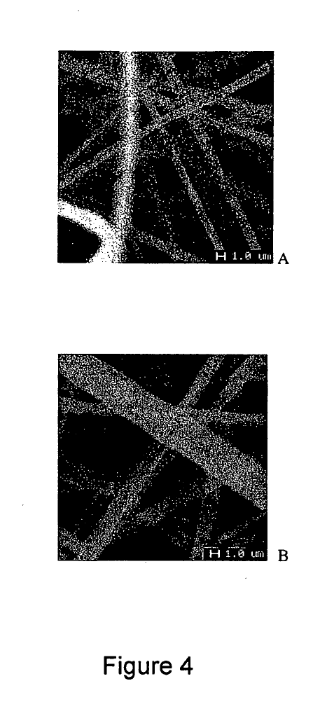

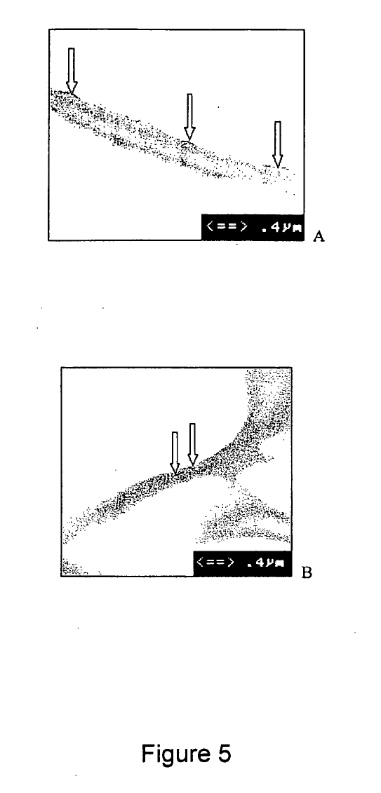

To avoid any nanoparticle sedimentation, each of these samples were then formed into micro- or nanofibers through the use of electrospinning as described above. Results may be seen in FIGS. 4 (SEM pictures) and 5 (TEM pictures).

All of the methods disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

### REFERENCES

The following references to the extent that they provide exemplary procedural or other details supplementary to those set forth herein, are specifically incorporated herein by reference.
U.S. Pat. No. 6,432,532
U.S. Pat. No. 6,382,526
U.S. Pat. No. 6,599,492
Ajayan et al., Science, 265:1212-1214, 1994.
Benitez et al., J. Material Proc. Tech., 190:324, 2007.
Calvert, Nature, 399:210-211, 1999.
Dauner, NanoEurope Conference, September 2006.
Demczyk et al., Materials Science and Engineering A, 334:173-178, 2002.
Dror et al., Langmuir, 19:7012-7020, 2003.
Jin et al., Appl. Phys. Lett., 73:1197-1199, 1998.
Kim and Lee, Polym. J, 32:616, 2000.
Lee et al., Polymer, 44:4029-4034, 2003.
Li and Xia, Adv. Mater., 16:1151-1170, 2004.
Lozano and Barrera, J. Appl. Polym. Sci., 79:125-133, 2001.
Lozano et al., Proceedings of the 1999 TMS Annual Meeting, 1999; San Diego, 333-340.
Lyon and Burgess, In: Carbon Black, Concise Encyclopedia of Polymer Science and Engineering, 1990. John Wiley & Sons, Inc., New York.
Macossay et al., Polym. Adv. Technol., 18:180-183, 2007.
Megelski et al., Macromolecules, 35:8456-8466, 2002.
Meo and Rossi, Comp. Sci. Tech., 66:1597-1605, 2006.
Qian et al., Appl. Phys. Lett., 76:2868-2870, 2000.
Qian et al., Appl. Phys. Lett., 76:2868-2870, 2000.
Quintero et al., Appl. Physics Lett., 90:1531-09, 2007.
Rasheed et al., Carbon, 45:1072-1080, 2007.
Robertson J. Realistic Applications of CNTs. Mater. Today 2004; 7: 46-52, 2004.
Salvetat et al., Appl. Phys., 69:255-260, 1999.
Salvetat-Delmotte and Rubio, Carbon, 40:1729-1734, 2002.
Schlumpf, Fillers and Reinforcements, Plastics Additives Handbook, 4th ed., 1996. Hanser/Gardner Publications, Cincinnati.
Shao et al., Materials Lett., 57:1579, 2003.
Stoy and Washabaugh, In: Fillers, Concise Encyclopedia of. Polymer Science and Engineering, John Wiley, NY, 1990
Xie et al. Mater. Sci. Eng. R, 49:89-112, 2005.
Yang et al., Polym. Degrad. Stab., 83:383, 2004.
Zong et al., Polymer, 43:4403-4412, 2002.

What is claimed is:

1. A fiber comprising a polymer selected from the group consisting a polyurethane, a polyamide, poly(methyl methacrylate), poly(vinyl chloride) and blends thereof, wherein the diameter of the fiber ranges from about 1 nm to about 2 μm.

2. The fiber of claim 1, wherein the molecular weight of the polymer ranges between about 20,000-500,000 g/mol.

3. The fiber of claim 2, wherein the molecular weight of the polymer ranges between about 100,000-300,000 g/mol.

4. The fiber of claim 1, wherein the fiber comprises a polyurethane.

5. The fiber of claim 4, wherein the polyurethane is further defined as a poly(ester urethane), a poly(carbonate urethane), a silicone containing poly(ether urethane), a silicone containing poly(ester urethane), a silicone containing poly(carbonate urethane), or blends thereof.

6. The fiber of claim 4, wherein the polyurethane is further defined as Lycra®, Hydrothane™, Elasthane™, Biospan®, or blends thereof.

7. The fiber of claim 1, wherein the fiber comprises a polyamide.

8. The fiber of claim 7, wherein the polyamide is further defined as Nylon or Nylon 6,6.

9. The fiber of claim 1, wherein the polymer comprises poly(methyl methacrylate) or poly(vinyl chloride).

10. The fiber of claim 1, wherein the fiber further comprises a nanoparticle.

11. The fiber of claim 10, wherein the nanoparticle is further defined as a carbon nanoparticle or an inorganic nanoparticle.

12. The fiber of claim 11, wherein the nanoparticle is further defined as a carbon nanoparticle.

13. The fiber of claim 12, wherein the carbon nanoparticle is a diamond nanoparticle, graphite nanoparticle, buckyball nanoparticle, amorphous carbon nanoparticle, carbon onion nanoparticle, carbon nanotube, or carbon nanofiber.

14. The fiber of claim 13, wherein the carbon nanoparticle is a carbon nanotube or a carbon nanofiber.

15. The fiber of claim 14, wherein the carbon nanotube or carbon nanofiber is further defined as an oxidized carbon nanotube or an oxidized carbon nanofiber, respectively.

16. The fiber of claim 11, wherein the nanoparticle is further defined as an inorganic nanoparticle.

17. The fiber of claim 16, wherein the inorganic nanoparticle is selected from the group consisting of nanosilica, nanotitania, nanobarium titanate and nano(γ-Fe₂O₃).

18. The fiber of claim 10, wherein the fiber comprises a plurality of nanoparticles.

19. The fiber of claim 18, wherein the plurality of nanoparticles comprise at least two types of nanoparticles.

20. The fiber of claim 18, wherein the total weight percentage of nanoparticles in the fiber ranges from about 0.001-10%.

21. The fiber of claim 1, wherein the fiber has a diameter of about 1-1000 nm.

22. The fiber of claim 1, wherein the fiber has a diameter of about 1-2 μm.

23. A nanofiber comprising:
(a) a polymer selected from the group consisting a polyurethane, a polyamide, poly(methyl methacrylate), poly(vinyl chloride) and blends thereof, and
(b) a nanoparticle.

24. The nanofiber of claim 23, wherein the nanoparticle is further defined as a carbon nanoparticle or an inorganic nanoparticle.

25. A method of making a fiber comprising:
(a) dispersing a plurality of nanoparticles into a polymer to form a nanoparticle-dispersed polymer; and
(b) creating a fiber from the nanoparticle-dispersed polymer,
wherein the diameter of the fiber ranges from about 1 nm to about 2 μm, and wherein the polymer is selected from the group consisting of a polyurethane, a polyamide, poly(methyl methacrylate), poly(vinyl chloride) and blends thereof.

26. The method of claim 25, wherein the nanoparticles are further defined as carbon nanoparticles or inorganic nanoparticles.

27. The method of claim 26, wherein the nanoparticles are further defined as carbon nanofibers, oxidized carbon nanofibers, carbon nanotubes, oxidized carbon nanotubes, nano-silica nanoparticles, nano-titania nanoparticles, nano-barium titanate nanoparticles, or nano(γ-Fe₂O₃) nanoparticles.

28. The method of claim 25, wherein the total percentage of nanoparticles added to the polymer ranges from about 0.001-10% wt/wt.

29. The method of claim 25, wherein the polymer is selected from the group consisting of Lycra®, Hydrothane™, Elasthane™, Biospan®, Nylon 6, Nylon 6,6, poly(methyl methacrylate) and poly(vinyl chloride).

30. The method of claim 25, wherein the polymer is dissolved in at least one solvent prior to dispersion of the nanoparticles.

31. The method of claim 30, wherein the solvent is selected from the group consisting of DMF, DMAC, THF, HFIP, N-cyclohexyl-2-pyrrolidone, formic acid, and mixtures thereof.

32. The method of claim 30, wherein the percentage of the polymer in the solvent ranges from about 1-25% wt/wt.

33. The method of claim 25, wherein the creation of the fiber is performed using electrospinning.

34. A method of making a nanofiber comprising:
(a) dispersing a plurality of nanoparticles into a polymer to form a nanoparticle-dispersed polymer; and
(b) electrospinning the nanoparticle-dispersed polymer to form the nanofiber,
wherein the polymer is selected from the group consisting of a polyurethane, a polyamide, poly(methyl methacrylate), poly(vinyl chloride) and blends thereof.
